(19) United States
(12) Patent Application Publication
(10) Pub. No.: US 2010/0199105 A1
(43) Pub. Date: Aug. 5, 2010

(54) METHOD FOR PLAYING DIGITAL CONTENTS AND MANAGING LICENSE AND APPARATUS THEREFOR

(75) Inventor: Sang Cheol LEE, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/695,375

(22) Filed: Jan. 28, 2010

(30) Foreign Application Priority Data
Feb. 2, 2009 (KR) 10-2009-0008132

(51) Int. Cl. G06F 21/00; G06F 12/14

(52) U.S. Cl. 713/189

(57) ABSTRACT

A method and apparatus for playing digital contents and managing a license, which encrypts a license for digital contents using an IMSI of a SIM card in a portable device, stores the encrypted license, and enables digital contents to be played using a license decrypted by a normal IMSI when the digital contents are requested to be played. In a method for playing digital contents in a portable device, which includes a subscriber identity module (SIM) card, the method includes: calling a license corresponding to the digital contents when the digital contents are requested to be played; when the license is an encrypted license, decrypting the encrypted license; and playing the digital contents as permitted by the decrypted license.

### CLAIM OF PRIORITY

This application claims the benefit of priority from Korean Patent Application No. 10-2009-0008132 filed in the Korean Intellectual Property Office on Feb. 2, 2009, the entire contents of which are incorporated herein by reference in its entirety.

### BACKGROUND OF THE INVENTION

1. Field of the Invention

The present invention relates to a method and apparatus for managing digital contents. More particularly, the present invention relates to a method and apparatus for managing license of digital contents, to which a Digital Rights Management (DRM) is applied, in a portable device so as to enhance protection of DRM contents.

2. Description of the Related Art

In order to prevent premium contents used by portable devices from being illegally copied or redistributed, Digital Rights Management (DRM) technology has been developed. The DRM is a technology for applying an encryption technique to various contents, such as documents, MP3 files, bell sounds, moving pictures, games, etc., so as to enable the rights of each corresponding copyright to be protected. DRM provides a series of protection and management systems at each step, from the creation of digital contents to publication, circulation, and the use thereof.

Therefore, contents (hereinafter, referred to as “DRM contents”) to which DRM is applied are always in an encrypted state so that only authorized users can decrypt and use the DRM contents. That is, although DRM contents can copied, unauthorized users cannot use the DRM contents because a specified license is required for using encrypted digital contents, in order to discourage illegal copying because of the inability to use the contents unless one is authorized.

The license to DRM content is issued by a rights issuing server (e.g. a DRM server), and is purchased by the digital content user. In addition, the license may be separated from digital contents and stored in a user device (e.g. a portable device) so as to restrict the execution of the corresponding contents. Typically, there are several types of DRM licenses that include variations of less than a wholesale purchase that include, for example, a count scheme, an interval scheme, a timed-count scheme, an accumulated scheme, etc.

The DRM license includes information that limits the use of DRM contents. For example, if the user purchases a license to play a specific MP3 file a total of ten times when purchasing the specific MP3 file, the user can play the MP3 file only a total of ten times. In this case, for example, the count is decreased by one whenever the MP3 file is played. When the count becomes “0” according to the tenth reproduction, the MP3 file cannot be played any more, requiring another purchase or extension of the DRM license. Hence, the reproduction of the MP3 file becomes possible only when the DRM license is additionally purchased. That is, in order to play the MP3 file, the user must additionally purchase the DRM license for access to use the MP3 file.

Meanwhile, as described above, the conventional DRM technology is designed to achieve only protection of DRM contents themselves by licenses using the count scheme, the interval scheme, the timed-count scheme, the accumulated scheme, etc. Also, in the conventional DRM technology, a usage is limited only to a user device. That is, only a corresponding portable device, which has acquired and stored DRM contents and a relevant license, can execute the DRM contents.

Therefore, in the conventional DRM technology, only protection of DRM contents themselves and protection to limit the usage bound to a particular user device are used for the protection of the DRM contents, thereby limiting the utilization boundaries of the DRM technology, and imposing restrictions on the usage of DRM contents by the user.

### SUMMARY OF THE INVENTION

The present invention provides a method and apparatus for restricting the usage of digital contents to the user and protecting the digital contents.

Also, the present invention provides a DRM contents management method and apparatus for providing various services and expanding unknown heretofore the DRM technology by restricting the playing of DRM contents to a corresponding user bound to a portable device.

In addition, the present invention provides a method and apparatus for increasing the security level of DRM technology by additionally encrypting a license for DRM contents in a portable terminal.

In accordance with an exemplary aspect of the present invention, a method for playing digital contents in a portable device which includes a subscriber identity module (SIM) card, the method comprises: calling a license corresponding to the digital contents when the digital contents are requested to be played; determining that the called license is an encrypted license, and decrypting the encrypted license; and playing the digital contents in accordance with the decrypted license. Preferably, wherein the digital contents have been encrypted, the decrypted license is utilized to decrypt and play the digital contents.

In accordance with another exemplary aspect of the present invention, a portable device comprises: a chip card comprising a subscriber identity module (SIM) card or a universal SIM (USIM) for storing subscriber identity information used for user identification; a storage unit for storing contents acquired from a source exterior to the portable device, and for storing a particular license corresponding to digital contents and a license encrypted according to a user bound setting; and a controller for encrypting and decrypting the particular license using the subscriber identity information of the SIM card, and managing the particular license according to whether the particular license comprises a non-encrypted license or an encrypted license.

### BRIEF DESCRIPTION OF THE DRAWINGS

The objects, features and advantages of the present invention will become more apparent to a person of ordinary skill in the art from the following detailed description in conjunction with the accompanying drawings, in which:

FIG. 1 schematically illustrates a system configuration for explaining a procedure for purchasing DRM contents and acquiring a license according to an exemplary embodiment of the present invention;

FIG. 2 is a flowchart illustrating a procedure of encrypting a license acquired by a portable device according to an exemplary embodiment of the present invention;

FIG. 3 is a flowchart illustrating a procedure of playing DRM contents in a portable device according to an exemplary embodiment of the present invention;

FIG. 4 is a block diagram schematically illustrating the internal configuration of a portable device equipped with a SIM card according to an exemplary embodiment of the present invention;

FIG. 5 is a flow diagram schematically illustrating a procedure of encrypting a license in a portable device according to an exemplary embodiment of the present invention; and

FIG. 6 is a flow diagram schematically illustrating a procedure of playing contents using an encrypted license in a portable device according to an exemplary embodiment of the present invention.

### DETAILED DESCRIPTION

Hereinafter, exemplary embodiments of the present invention are described in detail with reference to the accompanying drawings. The same reference numbers are used throughout the drawings to refer to the same or like parts. For the purposes of clarity and simplicity, detailed descriptions of well-known functions and structures incorporated herein may be omitted to avoid obscuring appreciation of the subject matter of the present invention by a person of ordinary skill in the art.

The present invention provides a method and apparatus for restricting the usage of digital contents to the user and protecting the digital contents. Especially, according to an exemplary embodiment of the present invention, there is a method and apparatus for restricting the usage of digital contents to the user and protecting the digital contents by additionally encrypting a license necessary for playing contents (hereinafter, referred to as “Digital Rights Management (DRM) contents”), to which DRM technology is applied, in a portable terminal.

To this end, according to an exemplary embodiment of the present invention, a chip card including a subscriber identity module (SIM) or universal SIM (USIM) for subscriber identification is used. Hereinafter, according to the claimed invention a chip card including the SIM or USIM will be inclusively designated as a “SIM card.” In addition, according to exemplary embodiments of the present invention, a person of ordinary skill in the art should understand and appreciate that in the claimed invention other types of modules and means having a function similar to that of the SIM card can be used in place of the SIM card.

Generally, the SIM card for subscriber identification is used in networks, including not only a Global System for Mobile Communication (GSM) network, which is the 2^{nd} generation communication network using an asynchronous communication scheme, but also a Universal Mobile Telecommunications System (UMTS) network and a General Packet Radio Services (GPRS) network cooperating with the Internet for the purpose of packet service, which are the 3^{rd} generation communication networks developed from the GSM network.

When a portable device equipped with a SIM card is to receive a service from one of the networks, the network first determines whether or not a corresponding subscriber is authorized to use the service by checking the subscriber identity information stored in the SIM card, and then the service is provided to the portable device when the corresponding subscriber is an authorized subscriber. Generally, the subscriber identity information stored in the SIM card includes an International Mobile Subscriber Identity (IMSI), which is a unique identity stored according to each SIM card.

Therefore, according to an exemplary embodiment of the present invention, an additional encryption is performed with respect to a license for specific DRM contents acquired through the use of the subscriber identity information uniquely allocated to the SIM card, and/or with respect to a license previously acquired and stored in the portable device. That is, when acquiring a license, the portable device encrypts the license with a specific encryption algorithm, and stores the encrypted license. Thus, preferably the DRM contents and the license can be encrypted.

In this exemplary case, the license may be distributed, with a function (hereinafter, referred to as a “user bound”) for implementing the present invention preset therein, and the portable device may determine setting information for the user bound when acquiring the license. When setting information for the user bound has been set in the corresponding license, the portable device may perform an additional encryption for the license. Also, with respect to an acquired license or a license previously stored in a storage unit, the portable device may determine whether or not to set the user bound and perform an additional encryption for the license, as requested by the user.

Herein, the encryption of a license by the specific encryption algorithm may be based on an encryption algorithm defined as an international standard. For example, according to an exemplary embodiment of the present invention, Data Encryption Standard (DES) encryption of the license using a DES encryption function may be performed. The DES encryption convert texts into an encrypted form through the use of a 64-bit key and an individual key encryption scheme, and according to an exemplary embodiment of the present invention, the encryption may be performed using an International Mobile Subscriber Identity (IMSI) value of a SIM card as an encryption key.

The IMSI value comprises a unique value allocated according to each SIM card, and generally, is constituted typically with a maximum 15 digit number. Specifically, the 15 digit number may include a Mobile Country Code (MCC) of 3 digits, a Mobile Network Code (MNC) of 2 or 3digits, and a Mobile Subscriber Identifier Number (MSIN) of maximum 10 digits. The MCC and MNC are used to identify a subscriber's home network, e.g. a Home Public Land Mobile Network (HPLMN), wherein a network (e.g. a PLMN) managed by each provider has a unique number. The MSIN represents a number for identifying the subscriber of a portable device, other than identifying a network as the MCC and MNC.

According to the present invention as described above, the DRM technology used in a portable device is further developed to restrict the usage of DRM contents to a user bound, so that it is possible to provide more various services and to expand the DRM technology. In addition, since the present invention is applied independently to various DRM schemes used in portable devices, the present invention can be used regardless of a particular type of DRM scheme applied to the portable devices. For one non-limiting example, even though any one scheme may be employed from among DRM schemes, including but not limited to a count scheme, an interval scheme, a timed-count scheme, an accumulated scheme, etc., the present invention can be applied.

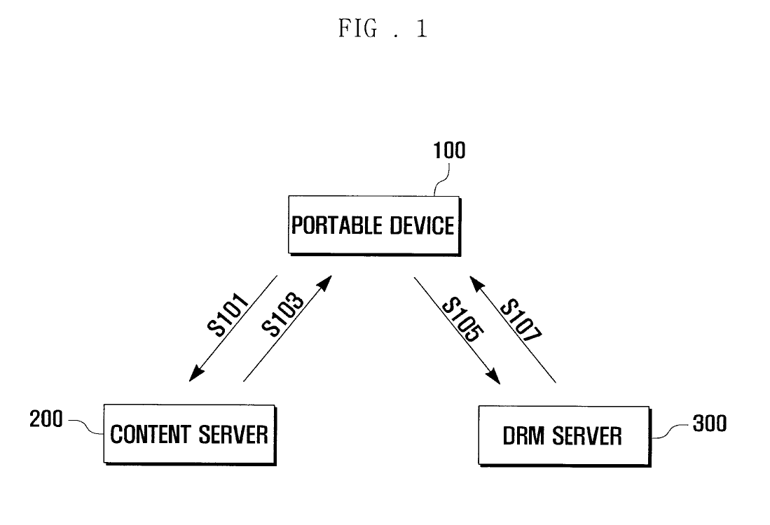

Hereinafter, a procedure for acquiring DRM contents and a license corresponding to the DRM contents in a portable device according to an exemplary embodiment of the present invention will now be described with reference to FIG. 1.

FIG. 1 schematically illustrates an exemplary system configuration for explaining a procedure for purchasing DRM contents and acquiring a license according to an exemplary embodiment of the present invention.

Referring now to FIG. 1, first, at step S101 a portable device 100 accesses a content server 200, which provides contents requested by the user, in order to purchase the contents, and then transmits a purchase request message to purchase the contents to the content server 200. Herein, the content server 200 may be a specific website server.

Then, at step S103, the content server 200 transmits the contents requested by the portable device 100 to the portable device 100 in step S103. In this case, it is assumed that the contents had the DRM technology applied thereto. That the DRM technology has been applied thereto represents that the contents have been encrypted using a predetermined encryption key and encryption scheme and that usage restriction information (e.g. a usage rule, the possible number of times of playing, a valid interval of playing, etc.) of the contents has been recorded based on a predetermined format.

Next, at step S105, when receiving the contents from the content server 200, the portable device 100 transmits a message to request a license for the received contents to a DRM server 300. The DRM server 300 may comprise a server which manages licenses for DRM contents. The license is an electronic certificate which grants the right to use predetermined DRM contents, and includes usage restriction information and a decryption key necessary for decrypting the predetermined DRM contents. Therefore, the portable device 100 must be granted a license stipulated in a DRM system in order to play contents to which the DRM technology is applied.

Next, at step S107, the DRM server 300 determines if the user of the portable device 100 is a user authorized to use the contents, and generates and transmits the requested license for the DRM contents to the portable device 100 when the determination of authorization is affirmative. In this case, the license may include usage restriction information and a decryption key for the contents. In addition, according to an exemplary embodiment of the present invention, the license may additionally include setting information that represents whether or not a user bound has been set.

Then, the portable device 100 can play the contents received from the content server 200 by means of the license received from the DRM server 300.

Specifically, according to an exemplary embodiment of the present invention, when acquiring the license from the DRM server 300, the portable device 100 may perform a process of determining whether the received license is to be encrypted, and encrypting the license according to a result of the determination.

That is, the portable device 100 may determine if the license includes user bound setting information, and perform an encryption for setting a user bound in the license when the license includes user bound setting information. Otherwise, when acquiring the license, the portable device 100 may perform an encryption for setting a user bound in the corresponding license in response to a user's request. Herein, the encryption may be performed using an IMSI of a SIM card as an encryption key value.

Next, with respect to the acquired license, the portable device 100 may store the license of which an additional encryption is omitted, or store the license encrypted through the additional encryption as described above. Thereafter, when it is requested to play the contents, the portable device 100 extracts the usage restriction information and the decryption key necessary for decrypting the contents from the stored license.

Herein, the decryption may be performed in different schemes depending on encryption states of licenses. That is, when a corresponding license comprise a normal license, in which encryption according to the present invention is omitted, the contents may be decrypted using a decryption key of the corresponding license. Also, when a corresponding license is a license encrypted using an IMSI as described in the embodiment of the present invention, the encrypted license is decrypted using the IMSI as a decryption key, and then the contents may be decrypted using a decryption key of the decrypted license (which is the same license as that first acquired from the DRM server) acquired by the decryption of the encrypted license.

The decryption of the license using the IMSI as a decryption key may be performed by a scheme corresponding to the aforementioned license encryption scheme using the IMSI, for example, by a scheme corresponding to the DES encryption scheme.

Therefore, when playing specific DRM contents, the portable device 100 decrypts the encrypted license using the IMSI of the SIM card as a decryption key, and acquires the same license (i.e. a decrypted license) as that initially received from the DRM server 300. Then, the portable device 100 can play the specific DRM contents using a decryption key of the decrypted license.

Meanwhile, when playing/accessing the specific DRM contents, the portable device 100 checks the number of times of playing and/or an interval of playing and/or so on, which are included in the extracted usage restriction information. In this case, when using the specific DRM contents is not in violation of the usage restriction information, the portable device 100 decrypts the contents by the decryption key of the license and then plays the contents.

Hereinafter, a method and apparatus for managing a license for DRM contents in a portable device according to an exemplary embodiment of the present invention will be described with reference to the accompanying drawings. However, it should be noted that the scope of the present invention is not limited to the exemplary embodiments described below, and the present invention can be applied to various embodiments in addition to the following exemplary embodiments.

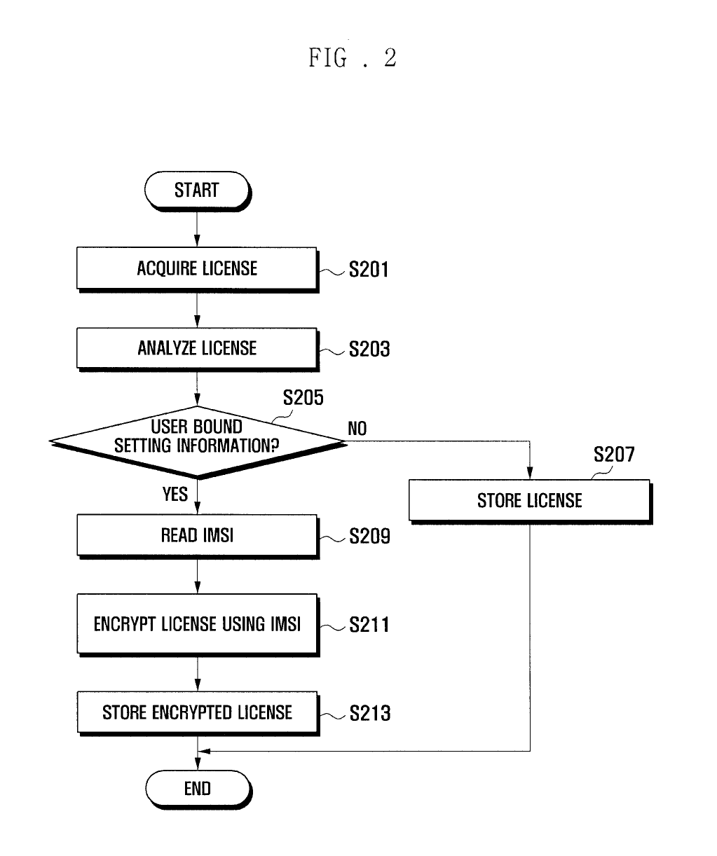

FIG. 2 is a flowchart illustrating a procedure of encrypting a license acquired by a portable device according to an exemplary embodiment of the present invention.

Referring now to FIG. 2, first, at step S201, the portable device 100 accesses the SIM card, from which the portable device 100 is to acquire a license for DRM contents, and acquires a license for the DRM contents through web browsing to the DRM server 300. The portable device 100 selects the DRM server 300, from which the portable device 100 is to acquire a license of the DRM contents, by making reference to the Uniform Resource Location (URL) information of the DRM server 300 included in the header information of the DRM contents, and then performs a web browsing procedure to the URL of the selected DRM server 300, so that the portable device 100 can download the license.

Next, at step S203, when acquiring the license for the DRM contents, the portable device 100 analyzes the acquired license prior to proceeding. Through the analysis, the portable device 100 determines whether or not the license includes the user bound setting information (step S205).

When as a result of the determination in step S205, it is determined that the license does not include user bound setting information, the portable device 100 stores the license acquired from the DRM server 300 in a storage unit in step S207.

In contrast, as a result of the determination in step S205, the license includes user bound setting information, and the portable device 100 reads an IMSI from a SIM card in step S209. That is, the portable device 100 calls an IMSI from the SIM card.

Then, at step S211, the portable device 100 encrypts the license using the called IMSI as an encryption key.

At step S213 and stores the encrypted license resulting from the encryption in a storage unit. The encryption may be performed by a preset encryption algorithm.

Meanwhile, although FIG. 2 illustrates the case where it is determined whether or not a license is to be encrypted depending on whether or not user bound setting information has been set in the license by the DRM server 300, the present invention is not limited thereto.

That is, when acquiring a license for the DRM contents, the portable device 100 can determine a processing scheme for the acquired license. Herein, a processing scheme for a license may be determined separately between a case where the license includes user bound setting information by the DRM server 300, and a case where the license is a normal license including no user bound setting information, as shown in FIG. 2. The operation for each case will now be schematically described.

When the license includes user bound setting information, the portable device 100 can determine whether or not to encrypt the license according to the procedure aforementioned with reference to FIG. 2. Otherwise, although the license includes user bound setting information, the portable device 100 may determine whether or not to encrypt the license in response to a user's request. That is, the portable device 100 may report that the corresponding license includes user bound setting information, and determine whether or not to encrypt the corresponding license based on a user's request based on the report.

When a license does not include user bound setting information, the portable device 100 may request the user to determine whether or not to encrypt the corresponding license, and determine whether or not to encrypt the corresponding license in response to a user's request based on the request of the portable device 100.

A method of encrypting a license acquired by a portable device according to an exemplary embodiment of the present invention has been explained above, but it should be noted that the exemplary embodiments above and the method of playing the portable device according to the present invention herein below and the appended claims are not limited to exemplary embodiments described herein.

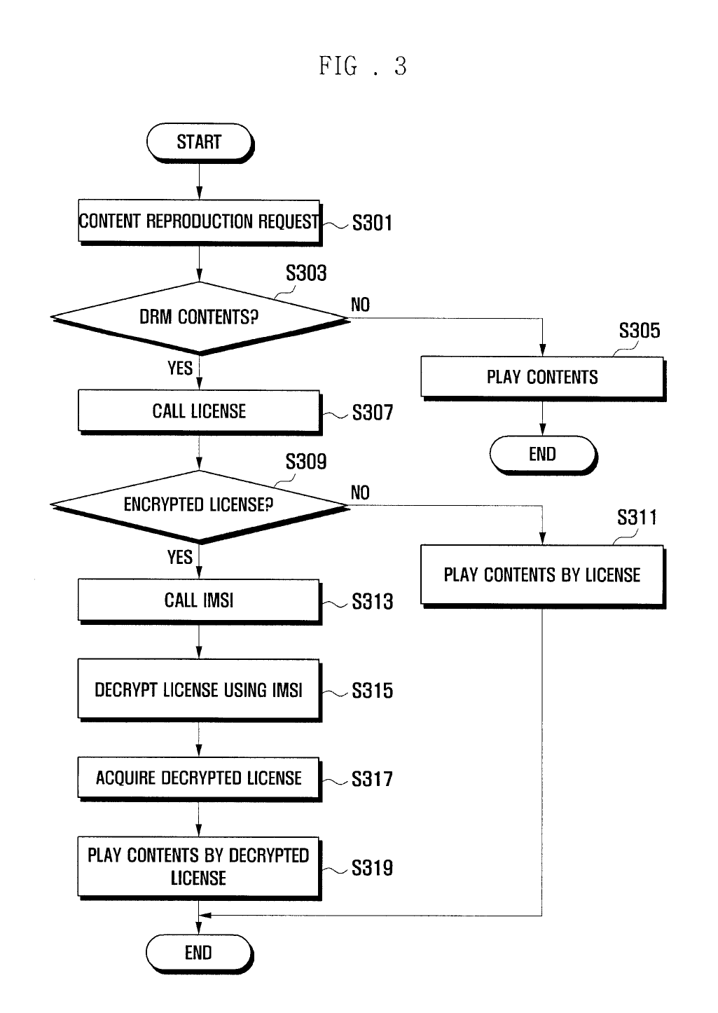

FIG. 3 is a flowchart illustrating a procedure of playing DRM contents in a portable device according to an exemplary embodiment of the present invention.

Referring now to FIG. 3, first, at step S301, when a portable device 100 senses a request to play predetermined contents from the user in step S301, at step S303 the portable device 100 determines the type of the play-requested contents. That is, the portable device 100 determines whether or not the contents correspond to DRM contents or to normal contents.

When the play-requested contents correspond to normal contents as a result of the determination in step S303, the portable device 100 plays the play-requested contents in step S305 without further determination.

However, at step S303, when the play-requested contents correspond to DRM contents as a result of the determination, the portable device 100 calls for (i.e. retrieves) a license corresponding to the DRM contents in step S307. That is, the portable device 100 extracts and reads a license corresponding to the DRM contents from a storage unit.

Next, at step S309, from reading the license, the portable device 100 determines whether or not the called license is in an encrypted state. That is, the portable device 100 determines whether the license corresponds to an encrypted license or a normal license according to user bound settings.

When the license corresponds to a normal license as a result of the determination in step S309, at step S311 the portable device 100 plays the DRM contents by the corresponding license without further action. That is, the portable device 100 extracts a usage restriction information and a decryption key used to decrypt the DRM contents from the license. Then, the portable device 100 checks the extracted usage restriction information, decrypts the DRM contents by the decryption key when playing the DRM contents is not in violation of the usage restriction information, and then plays the DRM contents.

However, when the license corresponds to an encrypted license as a result of the determination in step S309, the portable device 100 calls an IMSI from a SIM card in step S313. That is, the portable device 100 reads the IMSI as a decryption key to decrypt the encrypted license.

Next, the portable device 100 decrypts the encrypted license using the IMSI as a decryption key in step S315. Thus, the portable device 100 acquires a license (i.e. a decrypted license) for playing the DRM contents through the decryption using the IMSI in step S317. Then, the portable device 100 plays the DRM contents by the decrypted license acquired through the decryption in step S319.

That is, the portable device 100 acquires the decrypted license from the encrypted license, and extracts usage restriction information and a decryption key used to decrypt the DRM contents from the decrypted license. Then, the portable device 100 checks the extracted usage restriction information, decrypts the DRM contents by the second decryption key when playing the DRM contents is not in violation of the usage restriction information, and then plays the DRM contents. In this example, both the DRM contents and the license are decrypted, and only after the license is decrypted can the DRM contents be decrypted and played. Meanwhile, although it is not shown in FIG. 3, the procedure of FIG. 3 further includes a process of authenticating the IMSI when the encrypted license is decrypted using the IMSI. That is, the portable device 100 can prevent an unauthorized user from playing DRM contents by determining whether or not the SIM card is a proper SIM card.

More specifically, the portable device 100 may compare an IMSI of a SIM card and an IMSI which is an encryption key of an encrypted license, and determine whether or not the two IMSIs coincide with each other. In this case, when the two IMSIs coincide with each other, the SIM card is determined to be a proper SIM card, and the following process can be performed. In contrast, when the two IMSIs do not coincide with each other, the SIM card is determined to be an improper SIM card, the aforementioned DRM content playing process may be omitted.

In the above exemplary description, the operation of the system and portable device according to an exemplary embodiment of the present invention has been explained with reference to FIGS. 1 to 3. The following description will be given about the portable device 100 for performing the function of the present invention as described with reference to FIGS. 1 to 3. However, it should be noted that the portable device 100 according to the presently claimed invention is not limited to any configuration described below, and the present invention can be applied to various configurations in addition to the following exemplary embodiments.

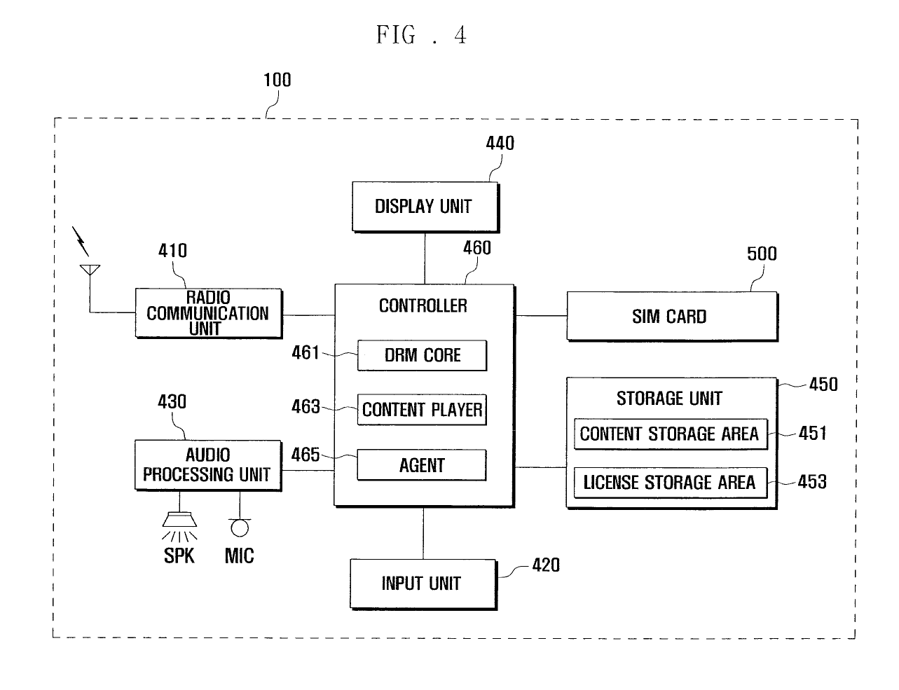

The portable device 100 described below according to the present invention includes a SIM card, and includes all types of mobile communication terminals which operate according to communication protocols corresponding to various communication networks. In addition, the portable device 100 according to the present invention can include all types of information and communication devices, multimedia devices, and their application devices, such as a Portable Multimedia Player (PMP), an MP3 player, a digital broadcast player, a Personal Digital Assistant (PDA), a smart phone, etc., which includes a function (e.g. a module having unique identification information) corresponding to the SIM card. Hereinafter, the configuration of the portable device 100 according to the present invention will be schematically described with reference to FIG. 4.

FIG. 4 is a block diagram schematically illustrating the internal configuration of a portable device equipped with a SIM card according to an exemplary embodiment of the present invention.

Particularly, although FIG. 4 illustrates the case where the portable device 100 according to the present invention comprises a mobile communication terminal equipped with a SIM card 500, the portable device 100 according to the presently claimed invention is not necessarily limited to the mobile communication terminal. In addition, internal blocks shown in FIG. 4 schematically illustrate only components required for performing the operation according to the present invention, and other components may be added in order to perform other functions of the portable device 100. Also, the SIM card 500 described with reference to FIGS. 1 to 4 is a card-shaped module which can be used in a GSM communication network that is the 2^{nd} generation communication network. Although the exemplary embodiments of the present invention are described with only the SIM card 500, it should be interpreted that the SIM card 500 includes all types of chip card modules, such as USIM cards, including unique identification information for portable device authentication or subscriber authentication, including permanent storage modules, as well as SIM cards.

Referring now to FIGS. 1 to 4, the present invention may be implemented roughly with the portable device 100 and the SIM card 500 which can be attached to/detached from the portable device 100 as shown in FIG. 4. The portable device 100 preferably includes a radio communication unit 410, an audio processing unit 430, a display unit 440, a storage unit 450, and a controller 460. In addition, the storage unit 450 includes a contents storage area 451 and a license storage area 453, and the controller 460 may include a DRM core 461, a content player 463, and an agent 465.

The SIM card 500 preferably comprises a card type module which can be attached to/detached from the portable device 100, and may include a microprocessor and a memory chip. The memory chip of the SIM card 500 may include various subscriber information, such as a user's personal phone number, a password, and billing account information, as well as an International Mobile Subscriber Identity (IMSI) which is unique subscriber identity information used to identify the subscriber.

The radio communication unit 410 controls communication of the portable device 100, in conjunction with the controller. The radio communication unit 410 forms a communication channel, which is set with a supportable mobile communication network, and performs communication, such as a voice call, a video telephony call, a data call, etc. The radio communication unit 410 may include a Radio Frequency (RF) transmitter for up-converting and amplifying the frequency of a signal to be transmitted, and an RF receiver for low-noise amplifying a received signal and down-converting the frequency of the received signal.

Particularly, the radio communication unit 410 can transmit/receive messages, or the like, which are connected with the purchase of at least one content and/or with the acquisition of a license for at least one content, in cooperation with external servers (e.g. a content server and a DRM server). The radio communication unit 410 can download DRM contents and/or a license necessary for playing specific DRM contents from the external servers according to the control of the controller 460. In addition, the radio communication unit 410 can transmit a license purchase request to the DRM server 300, and can receive a license and/or a response to the request from the DRM server 300 according to the control of the controller 460.

The input unit 420 receives various character information, and transfers to the controller 460 signals input in connection with settings of various functions and function controls of the portable device 100. The input unit 420 generates an input signal according to a user's action. To this end, the input unit 420 may include at least one of a keypad and a touch pad. The input unit 420 may be implemented in the form of one touch panel (or touch screen) including the display unit 440 therein so as to perform input and display functions at the same time. Particularly, the input unit 420 generates an input signal for a contents acquisition request and/or a license acquisition request according to the user's input, and then transfers the input signal to the controller 460.

With continued reference to FIG. 4, the audio processing unit 430 is connected in this example to a microphone MIC and a speaker SPK. The audio processing unit 430 converts a voice signal received through the microphone MIC into data and outputs the data, and also the audio processing unit 430 converts a voice signal input from the controller 460 into an audible sound through the speaker SPK and outputs the audible sound. That is, the audio processing unit 430 converts an analog voice signal input through the microphone MIC into a digital voice signal, and also converts a digital voice signal input from the controller 460 into an analog voice signal and outputs the analog voice signal through the speaker SPK. Particularly, the audio processing unit 430 can play audio components included in normal contents or DRM contents according to a user's selection.

The display unit 440 displays screen images generated while the functions of the portable device 100 are performed, and status information according to a user's key manipulation, function setting, etc. The display unit 440 visually displays various signals and color information output from the controller 460. Particularly, the display unit 440 displays screen images according to the playing of the contents, and also displays setting information according to a user bound of a license and request information for determining whether or not a license has been encrypted. When the display unit 440 is implemented in a touch screen scheme, the display unit 440 may operate as an input unit. A person of ordinary skill in the art should appreciate that in the presently claimed invention the functionality of one or more of the blocks shown in FIG. 4 could be combined, or further divided.

The storage unit 450 may be configured with, for example, a Read Only Memory (ROM), a Random Access Memory (RAM), etc. The storage unit 450 stores various data and the like which are generated and utilized by the portable device 100. The data includes data generated according to execution of an application on the portable device 100, and all types of storable data which are generated using the portable device 100 or are received from an exterior (e.g. a content server, a DRM server, a personal computer, another portable device, etc.). Particularly, the data includes normal contents, DRM contents, a license, and an encrypted license, and also may include a user interface provided in the portable device 100, various setting information according to the usage of the portable device 100, etc. The storage unit 450 may store the data necessary for communication through the radio communication unit 410.

Particularly, the storage unit 450 preferably includes the content storage area 451 and the license storage area 453, wherein the content storage area 451 stores contents acquired from an exterior, and the license storage area 453 stores a license acquired from an exterior, especially, from the DRM server 300, and an encrypted license obtained by encrypting a license according to setting of a user bound in the portable device 100. The storage unit 450 may store various setting information for processing the functions of the portable device 100. The storage unit 450 may store an application for controlling the general operation of the portable device 100, and an application for managing licenses and for controlling an operation to play contents.

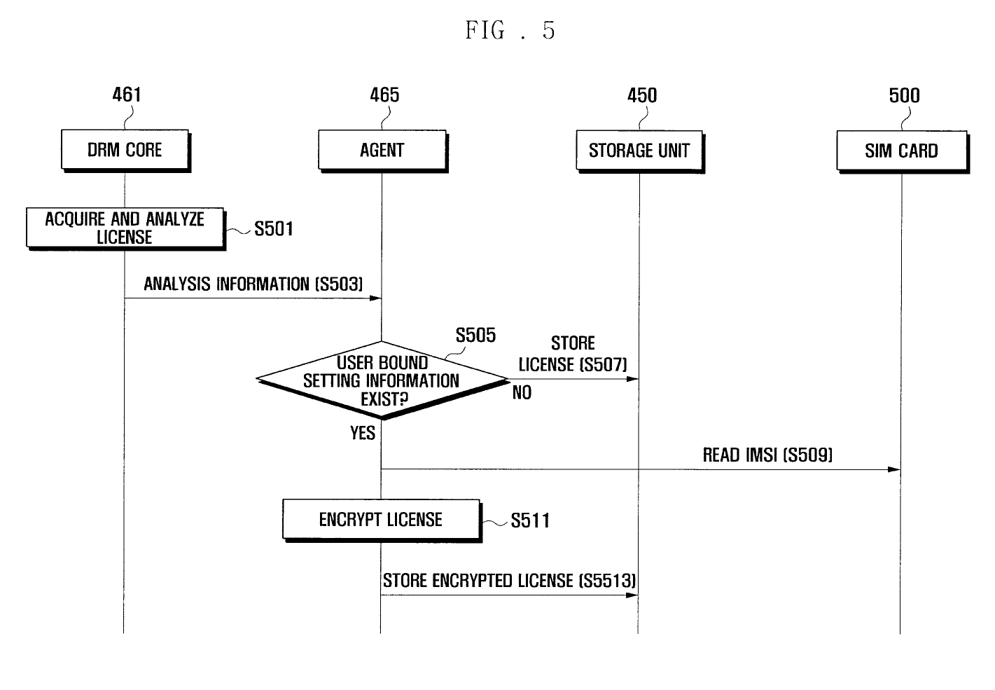

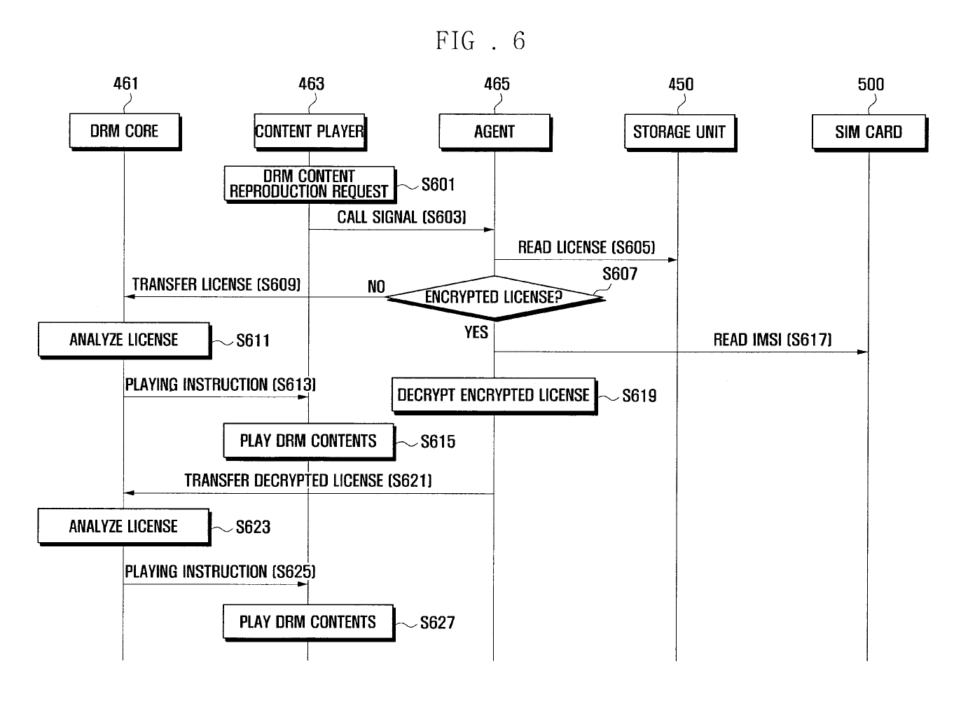

The operations of the present invention, as described above with reference to FIGS. 1 to 4 and described below with reference to FIGS. 5 and 6, may be stored in an application storage area (not shown) of the storage unit 450. Also, the storage unit 450 may include at least one buffer which temporarily stores data generated during the execution of the applications. In addition, the storage unit 450 may be configured inside of the portable device 100, or may be configured exterior, or partially exterior thereto as a smart card and so on. The storage unit 450 includes all types of internal/external storage media.

The controller 460 performs the overall control functions of the portable device 100, and controls signaling between blocks in the portable device 100. The controller 460 controls signaling between components, including the radio communication unit 410, the input unit 420, the audio processing unit 430, the display unit 440, the storage unit 450, the SIM card 500, etc.

Particularly, according to the present invention, the controller 460 encrypts and decrypts a license according to user bound settings. The controller 460 encrypts a license acquired from the DRM server 300 and/or a license stored in the storage unit 450 by means of an IMSI of the SIM card 500. The controller 460 may perform the encryption operation according to a preset encryption algorithm through the use of the IMSI as an encryption key.

Also, with continued reference to FIG. 4, the controller 460 decrypts a license which has been encrypted using the IMSI of the SIM card 500. The controller 460 may perform the decryption operation according to a preset decryption algorithm through the use of the IMSI as a decryption key. The controller 460 performs a control operation to play corresponding DRM contents by a normal license and/or a decrypted license obtained though the decryption.

The controller 460 preferably may include in this exemplary embodiment the DRM core 461, the content player 463, the agent 465, etc., which process the aforementioned functions.

The DRM core 461 represents various DRM cores used in the portable device 100. The DRM core 461 acquires a license from the DRM server 300, and analyzes whether the license is a normal license or a license encrypted according to user bound settings. Thereafter, the DRM core 461 transmits analysis information resulting from the analyzing to the agent 465. In addition, upon playing DRM contents, the DRM core 461 analyzes a license corresponding to the DRM contents, and controls the operation of the content player 463 according to conditions of the analyzed license.

The content player 463, when playing of contents is requested by the user, determines whether the requested contents correspond to DRM contents or normal contents. Thereafter, when the requested contents correspond to DRM contents, the content player 463 requests the agent 465 to acquire a license for the DRM contents. In addition, the content player 463, when playing DRM contents, preferably processes the playing of the DRM contents according to the control of the DRM core 461.

With continued reference to FIG. 4, the agent 465 in this example either directly stores the corresponding license in the storage unit 450 or reads an IMSI of the SIM card 500 according to the license analysis information transferred from the DRM core 461. The agent 465 encrypts the license using the IMSI as an encryption key and then stores the encrypted license in the storage unit 450.

In addition, the agent 465 preferably reads a license stored in the storage unit 450 in response to a request of the content player 463, and then determines whether or not the read license corresponds to a license encrypted according to user bound settings. When the read license has not been encrypted, the agent 465 omits a process of decrypting the read license and transfers the read license to the DRM core 461. In contrast, when the read license has been encrypted, the agent 465 reads an IMSI of the SIM card 500, decrypts the encrypted license, and then transfers the decrypted license to the DRM core 461.

The operation of each component of the controller 460 will now be described through signaling between each component with reference to FIGS. 5 and 6.

Meanwhile, the controller 460 performing the operations as described above can control the overall operation to achieve the present invention, as described above with reference to FIGS. 1 to 4 and described below with reference to FIGS. 5 and 6. The aforementioned function control of the controller 460 may be implemented by software so as to process the operations to achieve the present invention.

In addition, the controller 460 may include a baseband module for providing a mobile communication service to the portable device 100. Also, the baseband module may be arranged in the controller 460 and the radio communication unit 410, respectively, or may be configured separately from the controller 460 and the radio communication unit 410.

Meanwhile, although it is not shown in FIG. 4, the portable device 100 according to the present invention may further include at least a configuration selected from among a camera module for obtaining image data by photographing a subject, a digital broadcast receiving module for receiving a digital broadcast, a local area network module for local area communication, an Internet communication module for performing the Internet function in communication with the Internet, and the like, just to name a few possible configurations.

Hereinafter, the procedure for controlling the operations to achieve the present invention by each component included in the controller 460 will be described with reference to FIGS. 5 and 6.

FIG. 5 is a flow diagram schematically illustrating a procedure of encrypting a license in a portable device according to an exemplary embodiment of the present invention.

Referring to FIG. 5, first at step S501, when acquiring a specific license, the DRM core 461 analyzes the specific license and at step S503 transfers the resultant analysis information to the agent 465. The analysis information includes information on whether or not the license includes user bound setting information, information on whether there is encryption request information for the license according to a user's request, or the like.

When receiving the analysis information from the DRM core 461, at step S505 the agent 465 checks the analysis information and determines whether or not to encrypt the license. That is, the agent 465 judges if information representing that user bound setting information has been included is transferred, or if information (e.g. encryption request information) representing that encryption of the license has been requested by the user is transferred though the analysis information, and then determines whether or not to encrypt the license according to a result of the judgment. The agent 465 determines to encrypt the license when judging that user bound setting information or encryption request information is included through the analysis information, and may omit the encryption process when judging that user bound setting information and encryption request information are not included.

Therefore, when determining to omit the encryption process as a result of the judgment, the agent 465 preferably stores the license in the storage unit 450, specifically, in the license storage area 453 in step S507.

Also, when determining to perform the encryption as a result of the judgment, the agent 465 reads an IMSI of the SIM card 500 in step S509, and encrypts the license using the IMSI as an encryption key in step S511. Then, the agent 465 stores the encrypted license obtained by encrypting the license in the storage unit 450, specifically, in the license storage area 453 in step S513.

FIG. 6 is a flow diagram schematically illustrating a procedure of playing contents using an encrypted license in a portable device according to an exemplary embodiment of the present invention.

Referring now to FIG. 6, first, at step S601, when receiving a request to play contents from the user, the content player 463 checks the type of the play-requested contents. That is, the content player 463 judges whether or not the play-requested contents correspond to DRM contents or normal contents. FIG. 6 illustrates the case where the play-requested contents correspond to DRM contents, and a general reproduction procedure may be performed when the play-requested contents correspond to normal contents.

Therefore, at step S601, when receiving a request to play DRM contents from the user, the content player 463 at step S603 transfers a call signal for acquiring a license to the agent 465.

Then, at step S605, the agent 465 reads a license corresponding to the requested DRM contents from the storage unit 450 in response to the call signal received from the content player 463, and analyzes the read license.

Next, at step S607, the agent 465 judges whether or not the license read from storage comprises an encrypted license or a non-encrypted licenses.

When it is determined in step S607 that the read license is not an encrypted license, at step S609 the agent 465 transfers the read license to the DRM core 461.

At step S611, the DRM core 461 analyzes the non-encrypted license transferred from the agent 465, and transfers a playing instruction to operate according to conditions of the license to the content player 463 in step S613. That is, the DRM core 461 checks usage restriction information of the license, transfers a playing termination instruction of the DRM contents by the license when playing the DRM contents is in violation of the usage restriction information, and transfers a playing instruction of the DRM contents by the license when playing the DRM contents is not in violation of the usage restriction information. At step S615, the content player 463 plays the DRM contents in response to the playing instruction, or terminates the playing operation of the DRM contents.

When it is determined in step S607 that the read license comprises an encrypted license, at step S617, the agent 465 judges that the read license corresponds to a license in which a user bound has been set, and reads an IMSI of the SIM card 500.

At step S619, the agent 465 decrypts the encrypted license using the IMSI as a decryption key, and at step S621 transfers the decrypted license to the DRM core 461.

Then at step S623, the DRM core 461 analyzes the decrypted license transferred from the agent 465, and at step S625 transfers a playing instruction to operate according to conditions of the decrypted license to the content player 463. That is, the DRM core 461 checks usage restriction information of the decrypted license, transfers a playing termination instruction of the DRM contents by the decrypted license when playing the DRM contents is in violation of the usage restriction information, and transfers a playing instruction of the DRM contents by the decrypted license when playing the DRM contents is not in violation of the usage restriction information. The content player 463, at step S 627, plays the DRM contents in response to the playing instruction, or terminates the playing operation of the DRM contents.

Meanwhile, although it is not described in the specification with reference to FIGS. 1 to 6, the encryption of a license can be performed with respect to all licenses stored in the storage unit 450 of the portable device 100, as well as any license acquired from the DRM server 300. In this case, the encryption using an IMSI of the SIM card 500 can be collectively performed with respect to all licenses non-encrypted according to user bound settings in the storage unit 450 of the portable device 100.

As described above, according to the exemplary embodiments of the present invention, the user can play DRM contents purchased by himself/herself by installing only his/her own SIM card on any portable device. In addition, although the user loses his/her portable device, it is possible to prevent DRM contents from being illegally played by an unauthorized user, who has found the lost portable device and to prevent usage restriction information from being counted, because the DRM contents can be played only by a corresponding SIM card.

As described above, according to a method and apparatus for playing DRM contents and managing a license for the DRM contents, which is proposed by the present invention, protection of DRM contents based on the DRM technology can be achieved with protection to restrict the usage only to the user who has purchased the DRM contents, in addition to protection of the DRM contents themselves and protection to restrict the usage to a user device. Accordingly, it is possible to be more flexible to the DRM technology and DRM content market, so that the user convenience is enhanced.

According to the present invention, any portable device can play DRM contents purchased by the user, only when a SIM card or a module having a function corresponding to the SIM card is equipped on the portable device. Therefore, the user can use DRM contents without restriction to portable devices and/or space.

Also, according to the present invention, in a case where the user loses his/her portable device (or it is stolen), an unauthorized user cannot play DRM contents, so that it is possible to protect the DRM contents from illegal usage. That is, when the portable device is driven by a second SIM card, other than a first SIM card (i.e. the user's SIM card) used on license encryption, or when an unauthorized user who has found the lost portable device tries to drive the lost portable device, it is possible to protect the DRM contents.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Meanwhile, since the exemplary embodiments of the present invention disclosed in the specification and drawings show specific examples presented for a better understanding of the technical aspects of the present invention only, the scope of the present invention is not limited thereto. Although exemplary embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims.

What is claimed is:

1. A method for playing digital contents in a portable device which comprises a subscriber identity module (SIM) card, the method comprising:
calling a license corresponding to the digital contents when the digital contents are requested to be played;
determining that the called license is an encrypted license, and decrypting the encrypted license; and
playing the digital contents in accordance with the decrypted license.

2. The method according to claim 1, wherein the digital contents are encrypted, and the decrypted license is utilized to decrypt and play the digital contents; and
wherein a subscriber identity is contained in a chip card comprising either the SIM card or a universal SIM (USIM) card.

3. The method as claimed in claim 1, wherein the decrypting the encrypted license comprises:
acquiring subscriber identity information from the SIM card when the license is an encrypted license; and
decrypting the encrypted license only when the subscriber identity information in the SIM card indicates a corresponding subscriber is an authorized subscriber.

4. The method as claimed in claim 3, further comprising encrypting an acquired license by a set encryption algorithm and storing the encrypted license.

5. The method as claimed in claim 4, wherein the encrypting is performed using the subscriber identity information of the SIM card as an encryption key.

6. The method as claimed in claim 5, wherein the subscriber identity information corresponds to an International Mobile Subscriber Identity (IMSI) which is allocated uniquely to the SIM card.

7. The method as claimed in claim 5, comprising:
analyzing the license when the license is acquired from an external server; and
encrypting the license utilizing the subscriber identity information when the license includes user bound setting information.

8. The method as claimed in claim 6, comprising:
determining whether or not to set a user bound for the license according to a user's request when the license is acquired from an external server; and
encrypting the license by the subscriber identity information when determining to set the user bound in accordance with the user's request.

9. The method as claimed in claim 1, comprising, after the license calling:
checking if the license is in an encrypted state;
when the license has been encrypted, decrypting the encrypted license using the subscriber identity information; and
playing the digital contents according to the decrypted license generated through the decryption.

10. The method as claimed in claim 1, further comprising, when the license has not been encrypted, playing the digital contents according to the license.

11. A portable device comprising:
a chip card comprising a subscriber identity module (SIM) card or a universal SIM (USIM) for storing subscriber identity information used for user identification;
a storage unit for storing contents acquired from a source exterior to the portable device, and for storing a particular license corresponding to digital contents and a license encrypted according to a user bound setting; and
a controller for encrypting and decrypting the particular license using the subscriber identity information of the SIM card, and managing the particular license according to whether the particular license comprises a non-encrypted license or an encrypted license.

12. The portable device as claimed in claim 11, wherein the controller encrypts the particular license acquired from a DRM server and a license stored in the storage unit using the subscriber identity information of the SIM card.

13. The portable device as claimed in claim 12, wherein the controller performs encryption of the particular license using an International Mobile Subscriber Identity (IMSI), which is allocated uniquely to the SIM card, as an encryption key, so as to result in an encrypted license.

14. The portable device as claimed in claim 13, wherein the controller performs decryption of the encrypted license using the IMSI, as a decryption key.

15. The portable device as claimed in claim 14, wherein the controller comprises:
a DRM core for acquiring the particular license from the DRM server and for analyzing whether the acquired license comprises an encrypted license or a non-encrypted license; and
an agent for either storing the encrypted license in the storage unit or encrypting the non-encrypted license using the IMSI of the SIM card as an encryption key and storing the encrypted license in the storage unit, according to license analysis information transferred from the DRM core.

16. The portable device as claimed in claim 15, wherein the agent reads a particular license stored in the storage unit, reads the IMSI of the SIM card when the particular license comprises a license that has been encrypted according to a user bound setting, and decrypts the encrypted license.

17. The portable device as claimed in claim 14, wherein the controller checks if the particular license corresponding to the digital contents is in an encrypted state prior to playing the digital contents, decrypts the license using the subscriber identity information when the license has been encrypted, and plays the digital contents by the decrypted license generated through the decryption.

18. The portable device as claimed in claim 11, wherein the controller encrypts the acquired license using the subscriber identity information as an encryption key based on a set encryption algorithm, and stores the encrypted license in the storage unit.
